(19) United States
(12) Patent Application Publication
(10) Pub. No.: US 2022/0092697 A1
(43) Pub. Date: Mar. 24, 2022

(54) Deep Learning from Earning Calls for Stock Price Movement Prediction

(71) Applicant: S&P Global, New York, NY (US)

(72) Inventors: Zhiqiang Ma, Jersey City, NJ (US); Chong Wang, New York, NY (US); Xiaomo Liu, New York, NY (US)

(21) Appl. No.: 17/030,953

(22) Filed: Sep. 24, 2020

(51) Int. Cl. G06Q 40/06; G06N 3/08; G06N 3/04; G06F 17/18

(52) U.S. Cl. CPC G06Q 40/06; G06F 17/18; G06N 3/0454; G06N 3/08

(57) ABSTRACT

A method of predicting stock price movements. The method comprises extracting sentences from earning call transcripts related to a publicly traded stock. A neural network embedding layer encodes each extracted sentence into a sentence vector. An attention layer calculates an earning call vector that is a weighted sum of the sentence vectors. A recurrent neural network encodes a time series vector of historical prices for the stock. An attention layer assigns weights to time steps of the time series. An embedding layer encodes an industry sector vector representing categorical features of the sector to which the company belongs. A concatenated vector is calculated from the earning call representation call representation vector, the time series vector, and industry sector vector. A discriminative network predicts a direction of price movement of the stock over a future time period after a new earning call conference according to the concatenated vector.

### BACKGROUND INFORMATION

### 1. Field

The present disclosure relates generally to an improved computing system, and more specifically to a method for predicting the movement direction of stock prices based on insights from earning call transcripts, stock price history, and sector data.

### 2. Background

Earnings calls are hosted by management of publicly traded companies to discuss the company's financial performance with analysts and investors. Generally, the earnings calls are comprised of two components: 1) Presentation of recent financial performance by senior company executives and 2) a question and answer (Q&A) section between company management and market participants. Earnings calls comprise insights regarding current operations and outlook of companies, which could affect confidence and attitude of investors towards companies and therefore result in stock price movements. The presentation part of the earnings call is typically scripted and rehearsed, particularly in the face of bad news. The Q&A portion of the call incorporates unscripted and dynamic interactions between the market participants and management thus allowing for a more authentic assessment of a company.

Stock markets demonstrate notably higher levels of volatility, trading volume, and spreads prior to earnings announcements given the uncertainty in company performance. Such movements can be costly to the investors as they can result in higher trading fees, missed buying opportunities, or overall position losses.

Therefore, it would be desirable to have a method and apparatus that take into account at least some of the issues discussed above, as well as other possible issues.

### SUMMARY

An illustrative embodiment provides a computer-implemented method of predicting stock price movements. The method comprises using a number of processors to perform the steps of: extracting a number of sentences from a number of earning call transcripts related to a stock of a publicly traded company; encoding, by a first neural network embedding layer, each extracted sentence into a sentence vector; calculating, by a first neural network attention layer, an earning call representation vector that is a weighted sum of the sentence vectors; encoding, a by a recurrent neural network, a time series vector of historical prices for the stock over a specified time period; assigning, by a second neural network attention layer, weights to time steps comprising the time series vector; encoding, by a second neural network embedding layer, an industry sector vector representing categorical features of an industry sector to which the company belongs; calculating a concatenated vector from the earning call representation vector, the time series vector, and industry sector vector; and predicting, by a discriminative network according to the concatenated vector, a direction of price movement of the stock over a specified future time period after a new earning call conference.

Another embodiment provides a system for predicting stock price movements. The system comprises a storage device configured to store program instructions and one or more processors operably connected to the storage device and configured to execute the program instructions to cause the system to: extracting a number of sentences from a number of earning call transcripts related to a stock of a publicly traded company; encoding, by a first neural network embedding layer, each extracted sentence into a sentence vector; calculating, by a first neural network attention layer, an earning call representation vector that is a weighted sum of the sentence vectors; encoding, a by a recurrent neural network, a time series vector of historical prices for the stock over a specified time period; assigning, by a second neural network attention layer, weights to time steps comprising the time series vector; encoding, by a second neural network embedding layer, an industry sector vector representing categorical features of an industry sector to which the company belongs; calculating a concatenated vector from the earning call representation vector, the time series vector, and industry sector vector; and predicting, by a discriminative network according to the concatenated vector, a direction of price movement of the stock over a specified future time period after a new earning call conference.

Another embodiment provides a computer program product predicting stock price movements. The computer program product comprises a computer-readable storage medium having program instructions embodied thereon to perform the steps of: extracting a number of sentences from a number of earning call transcripts related to a publicly traded stock of a company; encoding, by a first neural network embedding layer, each extracted sentence into a sentence vector; calculating, by a first neural network attention layer, an earning call representation vector that is a weighted sum of the sentence vectors; encoding, a by a recurrent neural network, a time series vector of historical prices for the stock over a specified time period; assigning, by a second neural network attention layer, weights to time steps comprising the time series vector; encoding, by a second neural network embedding layer, an industry sector vector representing categorical features of an industry sector to which the company belongs; calculating a concatenated vector from the earning call representation vector, the time series vector, and industry sector vector; and predicting, by a discriminative network according to the concatenated vector, a direction of price movement of the stock over a specified future time period after a new earning call conference.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a stock movement prediction system in accordance with an illustrative embodiment;

FIG. 3 is a diagram that illustrates a node in a neural network in which illustrative embodiments can be implemented;

FIG. 4 is a diagram illustrating a neural network in which illustrative embodiments can be implemented;

FIG. 5 illustrates an example of a recurrent neural network in which illustrative embodiments can be implemented;

FIG. 6 depicts a neural network for learning earnings call vector representations in accordance with an illustrative embodiment;

FIG. 7 depicts an example display of weighted sentences from an earning call transcript in accordance with an illustrative embodiment;

FIG. 8 depicts an attentive, bi-direction recurrent neural network for calculating historic stock price time series in accordance with an illustrative embodiment;

FIG. 9 depicts an example of a log-return input sequence for the Bi-LSTM model in accordance with an illustrative embodiment;

FIG. 10 depicts a flowchart illustrating a process for predicting financial crises in accordance with an illustrative embodiment; and

FIG. 11 is a block diagram of a data processing system in accordance with an illustrative embodiment.

### DETAILED DESCRIPTION

The illustrative embodiments recognize and take into account one or more different considerations. The illustrative embodiments recognize and take into account that stock markets demonstrate higher levels of volatility, trading volume, and spreads prior to earnings announcements given the uncertainty in company performance. Therefore, the ability to accurately identify directional movements in stock prices based on earnings releases can be beneficial to investors by potentially minimizing their losses and generating higher returns on invested assets.

The illustrative embodiments also recognize and take into account that there has been significant research in modeling stock market movements using statistical and, more recently, machine learning models in the past few decades. However, it may not be sensible to directly predict future stock prices given the possibility that they follow a random pattern.

The illustrative embodiments also recognize and take into account that stock market prices are driven by a number of factors including news, market sentiment, and company financial performance. Predicting stock price movements based on market sentiment from the news and social media have been studied previously. However, earnings calls, which occur when companies report on and explain their financial results, have not been extensively studied for predicting stock price movements.

The illustrative embodiments provide a deep learning network to predict the stock price movement using text from earnings calls, historical stock prices, and industry sector date. To generate the textual feature, transcript sentences are represented as vectors by aggregating word embedding vectors. An attention mechanism is employed to capture their contributions to predictions. The historical stock price feature is produced by encoding a price time series date through a recurrent neural network (RNN) model. Discrete industry sectors of companies are encoded into learnable embedding vectors. The final prediction is made by a discriminative network by feeding in the transformed features.

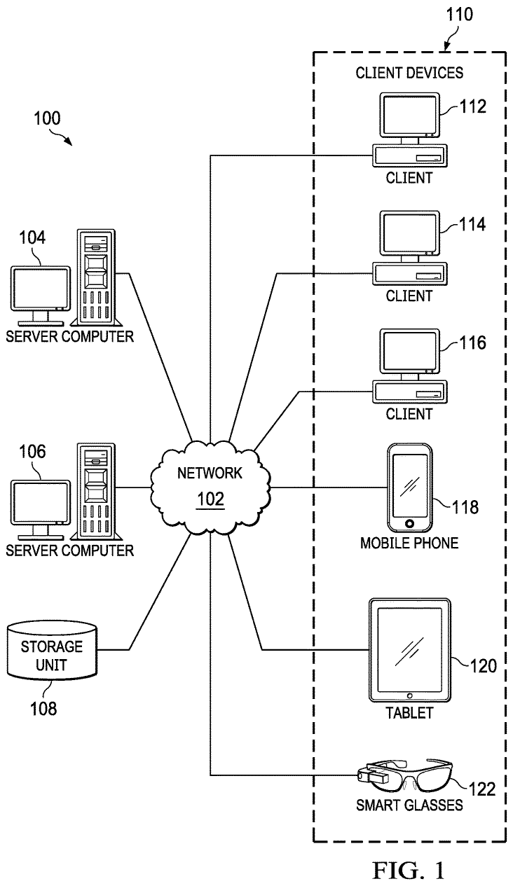

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

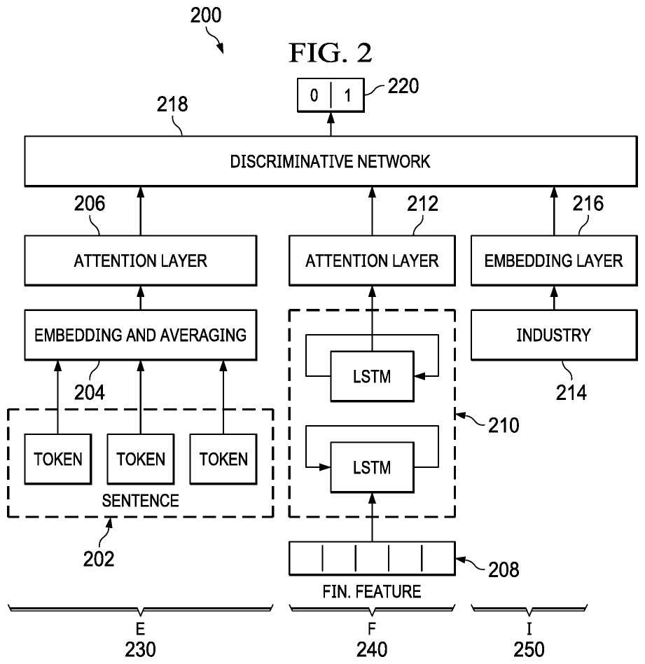

FIG. 2 depicts a block diagram of a stock movement prediction system in accordance with an illustrative embodiment. Stock movement prediction system 200 might be implemented in data processing system 100 in FIG. 1 and provides a prediction of the direction (up or down) of a stock price after an earning call conference. Assuming that there is a set of stocks

Θ={S1, S2, . . . , Sn} of n public companies. For a stock Sc, there exists a series of earnings call transcript ┌_{c}={T_{d1}, T_{d2}, . . . , T_{dm}}, which are held on day d₁, d₂, . . . , dₘ respectively. The goal is to predict the movement of the stock S_{c} on day d+α given the earnings call T_{d} occurred on day d, where Δ is a time interval in day(s). The movement y is a binary value, 0 (down) or 1 (up). The stock price in the market moves constantly in a trading day. To formally define y, the illustrative embodiments adopt the closing price, i.e. y=1 (p_{d+Δ}>p_{d}) , where p_{d} and p_{d+Δ} are the closing prices of day d and d 30 Δ.

The illustrative embodiment learn a prediction function y=f (E; F; I), which takes feature E extracted from an earnings call transcript T of a company, feature F from its stock price data, and its industry sector feature I as input, to predict the stock price movement y of the day after the earnings call.

Stock movement prediction system 200 is a neural network comprising three subnetworks 230, 240, and 250 that feed into discriminative network 218.

Subnetwork 230 calculates an earning call vector representing feature E extracted from the transcripts. Embedding and averaging layer 204 constructs vectors from sentences such as sentence 202, and attention layer 206 assigns weights to the vectors.

Subnetwork 240 creates a time series representing feature F from historic stock prices. Recurrent neural network 210 uses financial features (prices and volume) 208 to generate the time series, and attention layer 212 assigns weights to time steps within the time series.

Subnetwork 250 represents industry sector features I. Embedding layer 216 calculates a vector of industry categorical data 214 of the company's sector.

The respective outputs of subnetworks 230, 240, and 250 are concatenated and fed into discriminative network 218, which predicts a direction 220 (up or down) for the stock pricing following the latest earnings call.

Stock movement prediction system 200 can be implemented in software, hardware, firmware or a combination thereof. When software is used, the operations performed by stock movement prediction system 200 can be implemented in program code configured to run on hardware, such as a processor unit. When firmware is used, the operations performed by stock movement prediction system 200 can be implemented in program code and data and stored in persistent memory to run on a processor unit. When hardware is employed, the hardware may include circuits that operate to perform the operations in stock movement prediction system 200.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

These components can be located in a computer system, which is a physical hardware system and includes one or more data processing systems. When more than one data processing system is present in the computer system, those data processing systems are in communication with each other using a communications medium. The communications medium can be a network. The data processing systems can be selected from at least one of a computer, a server computer, a tablet computer, or some other suitable data processing system.

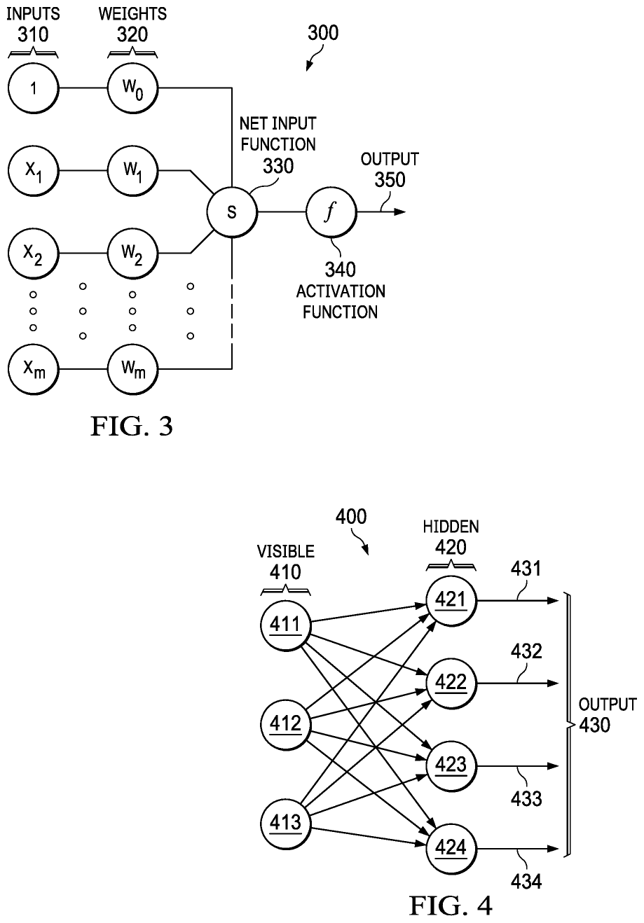

FIG. 3 is a diagram that illustrates a node in a neural network in which illustrative embodiments can be implemented. Node 300 combines multiple inputs 310 from other nodes. Each input 310 is multiplied by a respective weight 320 that either amplifies or dampens that input, thereby assigning significance to each input for the task the algorithm is trying to learn. The weighted inputs are collected by a net input function 330 and then passed through an activation function 340 to determine the output 350. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

FIG. 4 is a diagram illustrating a neural network in which illustrative embodiments can be implemented. As shown in FIG. 4, the nodes in the neural network 400 are divided into a layer of visible nodes 410 and a layer of hidden nodes 420. The visible nodes 410 are those that receive information from the environment (i.e. a set of external training data). Each visible node in layer 410 takes a low-level feature from an item in the dataset and passes it to the hidden nodes in the next layer 420. When a node in the hidden layer 420 receives an input value x from a visible node in layer 410 it multiplies x by the weight assigned to that connection (edge) and adds it to a bias b. The result of these two operations is then fed into an activation function which produces the node's output.

In fully connected feed-forward networks, each node in one layer is connected to every node in the next layer. For example, node 421 receives input from all of the visible nodes 411-413 each x value from the separate nodes is multiplied by its respective weight, and all of the products are summed. The summed products are then added to the hidden layer bias, and the result is passed through the activation function to produce output 431. A similar process is repeated at hidden nodes 422-424 to produce respective outputs 432-434. In the case of a deeper neural network, the outputs 430 of hidden layer 420 serve as inputs to the next hidden layer.

Neural network layers can be stacked to create deep networks. After training one neural net, the activities of its hidden nodes can be used as inputs for a higher level, thereby allowing stacking of neural network layers. Such stacking makes it possible to efficiently train several layers of hidden nodes. Examples of stacked networks include deep belief networks (DBN), convolutional neural networks (CNN), and recurrent neural networks (RNN).

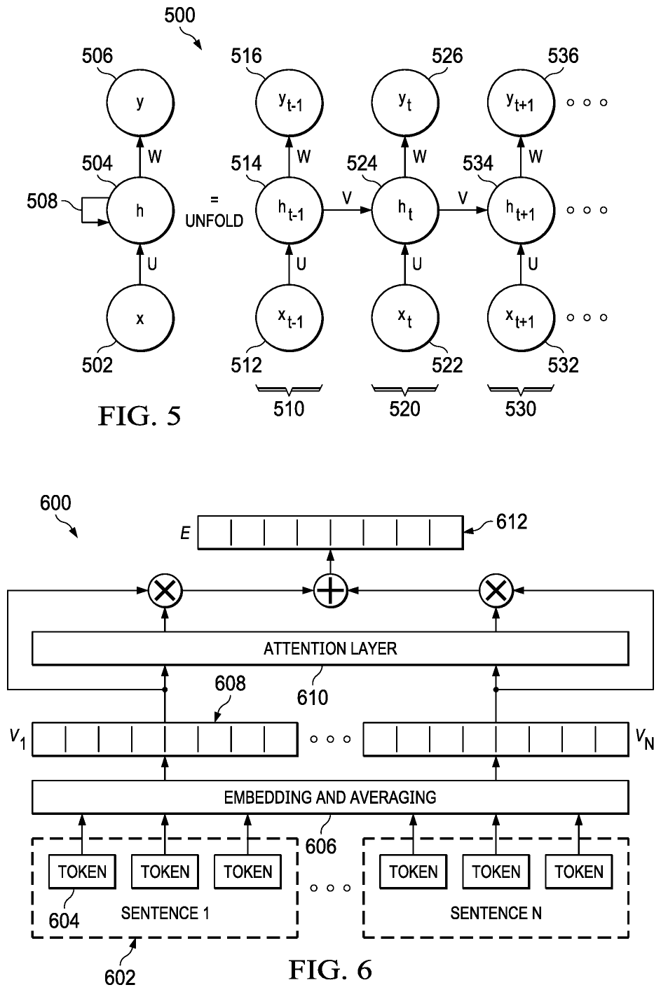

FIG. 5 illustrates an example of a recurrent neural network in which illustrative embodiments can be implemented. RNN 500 is an example of RNN 210 in FIG. 2. RNNs are recurrent because they perform the same task for every element of a sequence, with the output being depended on the previous computations. RNNs can be thought of as multiple copies of the same network, in which each copy passes a message to a successor. Whereas traditional neural networks process inputs independently, starting from scratch with each new input, RNNs persistence information from a previous input that informs processing of the next input in a sequence.

RNN 500 comprises an input vector 502, a hidden layer 504, and an output vector 506. RNN 500 also comprises loop 508 that allows information to persist from one input vector to the next. RNN 500 can be “unfolded” (or “unrolled”) into a chain of layers, e.g., 510, 520, 530 to write out the network 500 for a complete sequence. Unlike a traditional neural network, which uses different weights at each layer, RNN 500 shares the same weights U, W, V across all steps. By providing the same weights and biases to all the layers 510, 520, 530, RNN 500 converts the independent activations into dependent activations.

The input vector 512 at time step t-1 is xₜ₋₁. The hidden state hₜ₋₁ 514 at time step t−1, which is required to calculate the first hidden state, is typically initialized to all zeroes. The output vector 516 at time step t−1 is yt−1. Because of persistence in the network, at the next time step t, the state hₜ of the hidden layer 524 is calculated based on the previous hidden state hₜ₋1 514 and the new input vector xₜ 522. The hidden state hₜ acts as the “memory” of the network. Therefore, output yₜ 526 at time step t depends on the calculation at time step t−1. Similarly, output yₜ₊₁ 536 at time step t+1 depends on hidden state hₜ₊₁ 534, calculated from hidden state hₜ 524 and input vector xₜ₊₁ 532.

There are several variants of RNNs such as “vanilla” RNNs, Gated Recurrent Unit (GRU), and Long Short-Term Memory (LSTM).

FIG. 6 depicts a neural network for learning earnings call vector representations in accordance with an illustrative embodiment. Network 600 is an example detailed view of subnetwork 230 in FIG. 2.

A Q&A section of an earnings call transcript consists of multiple rounds of communications between analysts and company management executives. The illustrative embodiment might only use the Answer sections from management with the assumption that the answers are a more realistic representation of the feedback in which investors are interested. In the case where a response provided by managements does not answer a specific question, market participants typically follow up with clarifying questions to which they then receive required answers.

Given an earnings call transcript T, network 600 extracts the answer sequence A=[1₁, 1₂, . . . , 1_{N}] and A ∈ T, 1ᵢ denoting a sentence that comes from splitting the answer section. Network 600 treats one sentence as a feature atom and transforms each sentence to a dense vector. To achieve that transformation, each token o of a sentence, e.g., token 604 of sentence 1 602, is processed to a distributed representation vector eₒ by leveraging a pre-trained embedding layer 606. The sentence vector v₁ 608 for sentence 1 602 is constructed by averaging the token vectors across all the tokens of sentence 1 602. To reduce computing complexity, embedding layer 606 might not be trainable or fine-tuned.

Undoubtedly, some sentences convey more information while others not for the task of predicting stock price movements. The illustrative embodiments leverage the idea of the attention mechanism 610 introduced in the machine translation domain to learn the weights of the sentences. The weights quantify the contributions of the sentences to the final outcome. Given an answer sequence A consisting of N sentences and transformation of sentences to embedding vector vₛ, the attention weights α ∈ R^{1×N} are defined as normalized scores over all the sentences by a softmax function as shown below,

α₁=softmax(score(v₁)),

score (v₁)=u^{T}v₁+b

where u is a learnable parameter and b is a learnable bias parameter. The score function may be replaced with others depending on the specific task. By aggregating the sentence vectors weighted on the attention parameters, the earnings call answer sequence can be transformed to

$$E = {\sum }_{l}^{N} {α}_{l} {υ}_{l}$$

wherein E is the earning call representation vector 612.

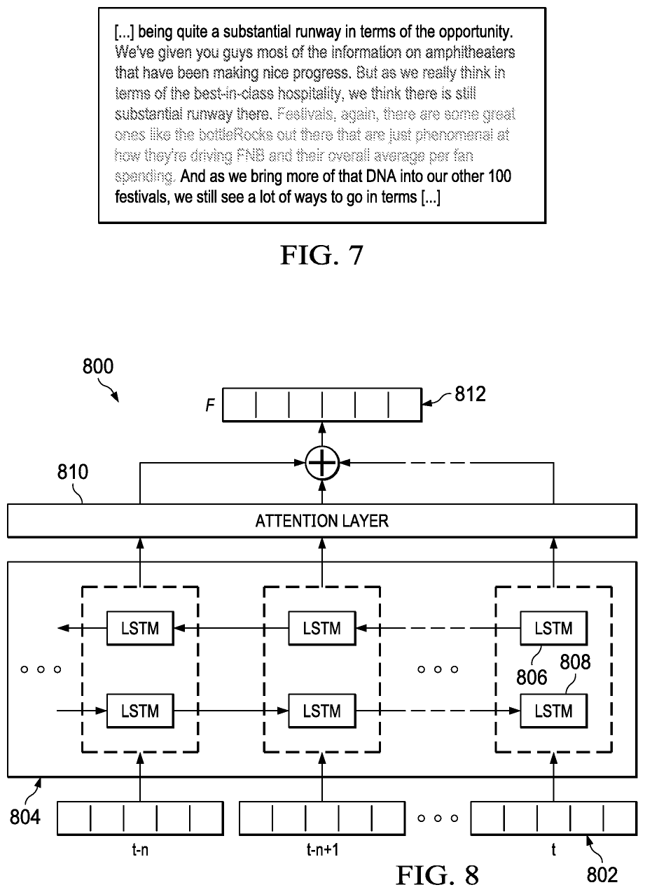

FIG. 7 depicts an example display of weighted sentences from an earning call transcript in accordance with an illustrative embodiment. To showcase the attention mechanism on sentences, the illustrative embodiments might use a visualization schema to display the varying attention scores among sentences, which also helps to understand what semantic information the model weights more. FIG. 7 shows an example snippet extracted from an earnings call transcript. The sentences are shaded differently according to the scale of their attention scores, darker shading standing for higher attention scores. Alternatively, attentions scores might also be color coded, e.g., higher chroma represent higher scores.

FIG. 8 depicts an attentive, bi-direction recurrent neural network for calculating historic stock price time series in accordance with an illustrative embodiment. Network 800 is an example detailed view of subnetwork 240 in FIG. 2.

Stock markets are intrinsically complex and dynamic. Investors have been leveraging technical analysis on historical stock price and trading volume when making buy and sell decisions, and the stock price time series data has been proved to be useful in related forecasting tasks. The illustrative embodiments include historical stock data in the model as well by employing an RNN, specifically a bidirectional LSTM (Bi-LSTM) structure to process the sequential stock price data.

Generally, daily stock price data contain five items: open price, close price, high price, low price, and volume. Rather than using these raw values, the illustrative embodiments normalize them by calculating their log-returns which is defined as

r_{d}=log (P_{d})−log (P_{d-Δ)}

where rd is the log-return for day d with a lag of Δ-day, and P_{d} and P_{d-A} are the stock price or volume of day d and d−Δ. The input to the Bi-LSTM model at each step t is Rₜ ∈ R^{1×5}.

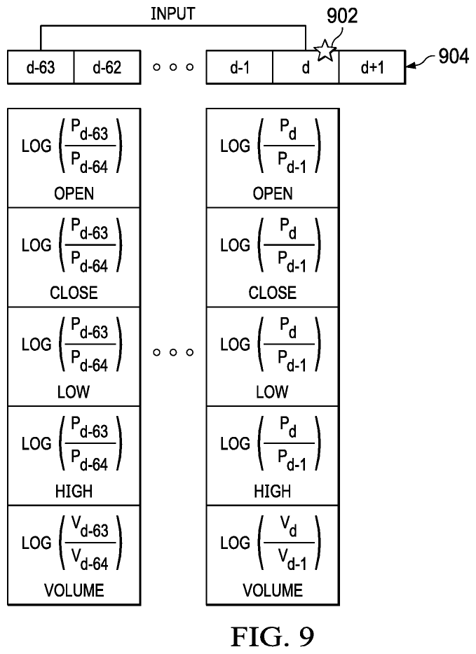

FIG. 9 depicts an example of a log-return input sequence (length=64) for the Bi-LSTM model in accordance with an illustrative embodiment. The earnings call conference happens on day d 902, and the forecast target is one day ahead d+1 904. It should be noted, when forecasting the stock price movement for the nth days after the earnings call, the historical log-returns input would be updated with lag Δ=n, i.e. the lag of the log-return always equal to the forecasting length.

RNNs are designed to process variable lengths of temporal sequences by recurrently feeding the information of the previous state to the next state so as to retain the past information. However, researchers have found that RNNs usually perform poorly in learning long sequences. To overcome the shortcomings of RNN, LSTM allows information passing through recurrent units through an added cell state, which furthermore enables forgetting or adding information controlled by gates.

Let hₜ₋₁ denote the hidden state of the previous step t−1 and xt denote the input of the current step t. Using the current LSTM unit at t as an example, the current hidden state hₜ is defined as

hₜ=oₜ° tanh (cₜ),

oₜ=σ(Wₒxₜ+Uₒhₜ₋₁+bₒ)

where oₜ is the output gate vector, cₜ is the cell state vector, and operator o means element-wise multiplication. The cell state vector cₜ is a combination of the previous cell state cₜ₋₁ passing through memory forgetting fₜ and the input gate vector iₜ multiplying its activation vector \tilde{c}ₜ, mathematically,

cₜ=fₜ° cₜ₋₁+iₜ° \tilde{c}ₜ,

\tilde{c}ₜ=σ(W_{c}xₜ+U_{c}hₜ₋₁+b_{c})

The forgetting gate throttles the information fed to the current step from the previous state, i.e., deciding what information to forget or remember moving forwarding. In contrast, the input gate controls the new information from xₜ and hₜ₋₁ added to the current cell state. Their definitions are

ft=σ(W_{f}xₜ+U_{f}hₜ₋₁+b_{f}),

it=σ(Wᵢxₜ+Uᵢhₜ₋₁+bᵢ)

The regular single directional RNN, e.g., left to right, can only access past information on the left at any particular time step. To overcome the limitation, bidirectional RNN [24] was proposed to use both forward and backward input information. The idea is to make the recurrent unit have two independent states, one for the forward direction and the other for the backward direction. Bi-LSTM has already been used to solve various sequential data modeling tasks. The hidden state output of Bi-LSTM at each step is simply the concatenation of the hidden state outputs of the two single directional LSTM networks, hₜ=[\vec{h}ₜ, [symbol] .

To encode the historical log-return data 802, the illustrative embodiment feeds the data into Bi-LSTM network 804, as the bottom two layers 806, 808 shown in FIG. 8. Network 800 further applies a temporal attention layer 810, which learns an attention score as to represent the varying contributions at different time steps to the overall representation of the whole sequence. The log-return vector representation F 812 is a weighted average over the hidden states of all the steps defined as follows

$$F = {\sum }_{t} {α}_{t}^{s} {h}_{t} , \\ {α}_{t}^{s} = softmax ( score ( {h}_{t} ) )$$

Company stock usually follows the trend of the industry sector to which the company belongs. The sector category and company sector definition vary in terms of standards. The illustrative embodiments might employ the Global Industry Classification Standard (GICS) definition. GICS consists of 11 industry sector categories such as, e.g., energy, financials, and health care. The industry sector is a categorical indicator. In machine learning, categorical data are usually transformed by one-hot encoding or ordinal encoding. The illustrative embodiment uses an embedding layer 216 to transform the categorical values into vector presentations I, which is learnable during the network training phase.

Referring back FIG. 2, with the feature representations E, F, and I built above as input, the final binary classification result is computed by a feed forward discriminative network 218. The feed forward network 218 might comprise multiple hidden layers such, e.g., batch normalization layer, dropout layer, rectified linear unit (ReLU) activation layer, and linear layer.

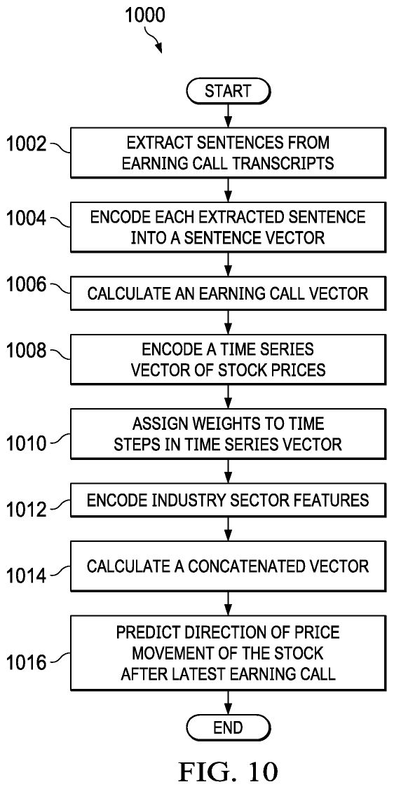

FIG. 10 depicts a flowchart illustrating a process for predicting financial crises in accordance with an illustrative embodiment. The process in FIG. 10 can be implemented in hardware, software, or both. When implemented in software, the process can take the form of program code that is run by one of more processor units located in one or more hardware devices in one or more computer systems. Process 1000 might be implemented in stock movement prediction system 200 shown in FIG. 2.

Process 1000 begins by extracting a number of sentences from earning call transcripts related to a stock of a publicly traded company (step 1002). In an embodiment, the sentences extracted from the earning call transcripts comprise answers to questions in the Q&A sections of the transcripts.

An embedding layer in a neural network encodes each extracted sentence into a respective sentence vector (step 1004). Each sentence vector can be constructed by encoding each token in the sentence into a distributed token vector and then averaging the token vectors across all the tokens of the sentence.

An attention layer in the neural network then calculates an earning call representation vector that is a weighted sum of the sentence vectors (step 1006). In an embodiment the earning call transcripts might be displayed wherein each sentence is visualized in specific manner indicating the weight assigned to it by the attention layer.

A recurrent neural network encodes a time series vector of historical prices for the stock over a specified time period (step 1008). In an embodiment, the RNN comprises a bi-directional, long short-term memory network (Bi-LSTM). The time series vector can be calculated with daily stock price data comprising log-return values for opening price, closing price, high price, low price, and trading volume of the stock. An attention layer assigns weights to the time steps comprising the time series vector (step 1010).

Another neural network embedding layer encodes an industry sector vector representing categorical features of the industry sector to which the company belongs (step 1012). Encoding the industry sector vector might comprise encoding categorical sector data with randomly assigned weights and tuning the weights during training of the embedding layer.

A concatenated vector is calculated from the earning call representation vector, the time series vector, and industry sector vector (step 1014). A discriminative network uses the concatenated vector to predict a direction of price movement (up or down) of the stock over a specified future time period after a new (latest) earning call conference. Process 1000 then ends.

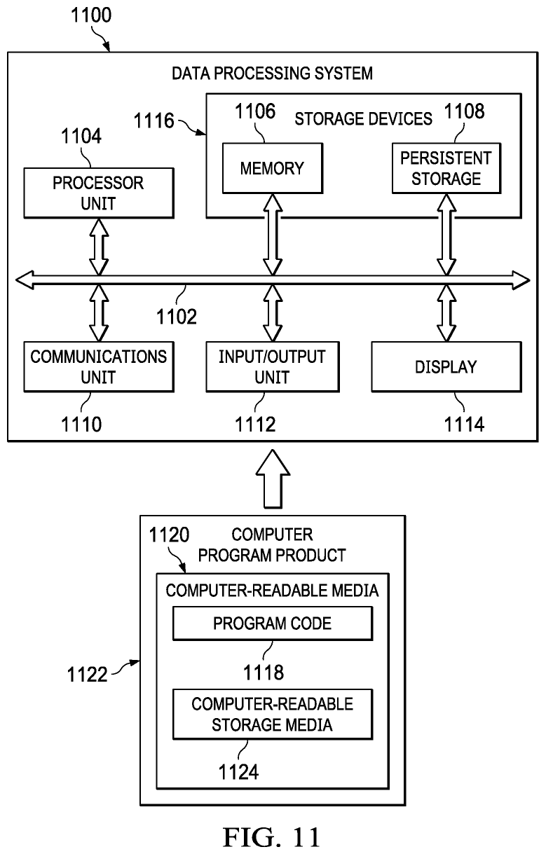

Turning now to FIG. 11, a block diagram of a data processing system is depicted in accordance with an illustrative embodiment. Data processing system 1100 can be used to implement server computer 104, server computer 106, client devices 110, in FIG. 1. Further, data processing system 700 can also be used to implement one more components in crisis prediction system 200 in FIG. 2. In this illustrative example, data processing system 1100 includes communications framework 1102, which provides communications between processor unit 1104, memory 1106, persistent storage 1108, communications unit 1110, input/output (I/O) unit 1112 and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor.

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

Persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program code, computer usable program code, or computer-readable program code that can be read and executed by a processor in processor unit 1104. The program code in the different embodiments can be embodied on different physical or computer-readable storage media, such as memory 1106 or persistent storage 1108.

Program code 1118 is located in a functional form on computer-readable media 1120 that is selectively removable and can be loaded onto or transferred to data processing system 1100 for execution by processor unit 1104. Program code 1118 and computer-readable media 1120 form computer program product 1122 in these illustrative examples. In the illustrative example, computer-readable media 1120 is computer-readable storage media 1124.

In these illustrative examples, computer-readable storage media 1124 is a physical or tangible storage device used to store program code 1118 rather than a medium that propagates or transmits program code 1118.

Alternatively, program code 1118 can be transferred to data processing system 1100 using a computer-readable signal media. The computer-readable signal media can be, for example, a propagated data signal containing program code 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1120” can be singular or plural. For example, program code 1118 can be located in computer-readable media 1120 in the form of a single storage device or system. In another example, program code 1118 can be located in computer-readable media 1120 that is distributed in multiple data processing systems. In other words, some instructions in program code 1118 can be located in one data processing system while other instructions in program code 1118 can be located in a separate data processing system. For example, a portion of program code 1118 can be located in computer-readable media 1120 in a server computer while another portion of program code 1118 can be located in computer-readable media 1120 located in a set of client computers.

The different components illustrated for data processing system 1100 are not meant to provide architectural limitations to the manner in which different embodiments can be implemented. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program code 1118.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, the 1106, or portions thereof, may be incorporated in processor unit 1104 in some illustrative examples.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of predicting stock price movements, the method comprising:
using a number of processors to perform the steps of:
extracting a number of sentences from a number of earning call transcripts related to a stock of a publicly traded company;
encoding, by a first neural network embedding layer, each extracted sentence into a sentence vector;
calculating, by a first neural network attention layer, an earning call representation vector that is a weighted sum of the sentence vectors;
encoding, a by a recurrent neural network, a time series vector of historical prices for the stock over a specified time period;
assigning, by a second neural network attention layer, weights to time steps comprising the time series vector;
encoding, by a second neural network embedding layer, an industry sector vector representing categorical features of an industry sector to which the company belongs;
calculating a concatenated vector from the earning call representation vector, the time series vector, and industry sector vector; and
predicting, by a discriminative network according to the concatenated vector, a direction of price movement of the stock over a specified future time period after a new earning call conference.

2. The method of claim 1, wherein the sentences extracted from the earning call transcripts comprise answers to questions.

3. The method of claim 1, wherein each sentence vector is constructed by:
encoding each token in the sentence into a distributed token vector; and
averaging the token vectors across all the tokens of the sentence.

4. The method of claim 1, wherein the time series vector is calculated with daily stock price data comprising log-return values for:
opening price;
closing price;
high price;
low price; and
volume.

5. The method of claim 1, wherein the recurrent neural network comprises a bi-directional, long short-term memory network.

6. The method of claim 1, wherein encoding the industry sector vector comprises:
encoding categorical sector data with randomly assigned weights; and
tuning the weights during training of the second neural network embedding layer.

7. The method of claim 1, further comprising displaying the earning call transcripts, wherein each sentence is visualized in specific manner indicating a weight assigned to it by the first neural network attention layer.

8. A system for predicting stock price movements, the system comprising:
a storage device configured to store program instructions; and
one or more processors operably connected to the storage device and configured to execute the program instructions to cause the system to:
extracting a number of sentences from a number of earning call transcripts related to a stock of a publicly traded company;
encoding, by a first neural network embedding layer, each extracted sentence into a sentence vector;
calculating, by a first neural network attention layer, an earning call representation vector that is a weighted sum of the sentence vectors;
encoding, a by a recurrent neural network, a time series vector of historical prices for the stock over a specified time period;
assigning, by a second neural network attention layer, weights to time steps comprising the time series vector;
encoding, by a second neural network embedding layer, an industry sector vector representing categorical features of an industry sector to which the company belongs;
calculating a concatenated vector from the earning call representation vector, the time series vector, and industry sector vector; and
predicting, by a discriminative network according to the concatenated vector, a direction of price movement of the stock over a specified future time period after a new earning call conference.

9. The system of claim 8, wherein the sentences extracted from the earning call transcripts comprise answers to questions.

10. The system of claim 8, wherein each sentence vector is constructed by:
encoding each token in the sentence into a distributed token vector; and
averaging the token vectors across all the tokens of the sentence.

11. The system of claim 8, wherein the time series vector is calculated with daily stock price data comprising log-return values for:
opening price;
closing price;
high price;
low price; and
volume.

12. The system of claim 8, wherein the recurrent neural network comprises a bi-directional, long short-term memory network.

13. The system of claim 8, wherein encoding the industry sector vector comprises:
encoding categorical sector data with randomly assigned weights; and
tuning the weights during training of the second neural network embedding layer.

14. The system of claim 8, wherein the processors further execute instructions to display the earning call transcripts, wherein each sentence is visualized in specific manner indicating a weight assigned to it by the first neural network attention layer.

15. A computer program product predicting stock price movements, the computer program product comprising:
a computer-readable storage medium having program instructions embodied thereon to perform the steps of:
extracting a number of sentences from a number of earning call transcripts related to a stock of a publicly traded company;
encoding, by a first neural network embedding layer, each extracted sentence into a sentence vector;
calculating, by a first neural network attention layer, an earning call representation vector that is a weighted sum of the sentence vectors;
encoding, a by a recurrent neural network, a time series vector of historical prices for the stock over a specified time period;
assigning, by a second neural network attention layer, weights to time steps comprising the time series vector;
encoding, by a second neural network embedding layer, an industry sector vector representing categorical features of an industry sector to which the company belongs;
calculating a concatenated vector from the earning call representation vector, the time series vector, and industry sector vector; and
predicting, by a discriminative network according to the concatenated vector, a direction of price movement of the stock over a specified future time period after a new earning call conference.

16. The computer program product of claim 15, wherein the sentences extracted from the earning call transcripts comprise answers to questions.

17. The computer program product of claim 15, wherein each sentence vector is constructed by:
encoding each token in the sentence into a distributed token vector; and
averaging the token vectors across all the tokens of the sentence.

18. The computer program product of claim 15, wherein the time series vector is calculated with daily stock price data comprising log-return values for:
opening price;
closing price;
high price;
low price; and
volume.

19. The computer program product of claim 15, wherein the recurrent neural network comprises a bi-directional, long short-term memory network.

20. The computer program product of claim 15, wherein encoding the industry sector vector comprises:
encoding categorical sector data with randomly assigned weights; and
tuning the weights during training of the second neural network embedding layer.
